(19) United States
(12) Patent Application Publication
(10) Pub. No.: US 2011/0305465 A1
(43) Pub. Date: Dec. 15, 2011

(54) IMAGE FORMING APPARATUS AND IMAGE FORMING METHOD

(75) Inventor: Toshifumi Mimura, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/116,211

(22) Filed: May 26, 2011

Related U.S. Application Data
(60) Provisional application No. 61/352,963, filed on Jun. 9, 2010.

(51) Int. Cl. G03G 15/00; B41J 29/38

(52) U.S. Cl. 399/12; 347/6; 399/49

(57) ABSTRACT

According to one embodiment, an image forming apparatus includes an image forming section configured to form an image and output the image to a medium, at least one or more detachable consumables including storage media having predetermined information stored therein, a reading module configured to read the predetermined information from the storage media, and a controller configured to output, if the image forming apparatus is instructed to start a predetermined operation and the controller determines that the predetermined information is not present in a storage medium of a consumable related to the operation, a message for urging a user to input an instruction for executing a process for extracting an image forming condition corresponding to the consumable and, if an instruction for executing the process is input, start the predetermined operation after executing operation for extracting a condition for forming an image.

### CROSS-REFERENCE TO RELATED APPLICATIONS

This application is based upon and claims the benefit of U.S. Provisional Application No. 61/352,963, filed on Jun. 9, 2010; the entire contents of which are incorporated herein by reference.

### FIELD

Embodiments described herein relate generally to an image forming apparatus and an image forming method.

### BACKGROUND

In the past, in an image forming apparatus of an electrophotographic system, an image forming apparatus of an ink jet system, or the like, various consumables are used. The consumables include genuine products provided by a manufacturer of the image forming apparatus and non-genuine products provided by others more inexpensive than the genuine products.

The manufacturer manages the standards of the genuine products using the genuine products in the image forming apparatus such that stable image quality can be provided. In some case, a function of correcting deterioration in the genuine products is provided in the image forming apparatus. However, since the non-genuine products are manufactured with priority given to cost, most of the non-genuine products do not satisfy the required standards. Therefore, it is pointed out that the image forming apparatus cannot properly correct the deterioration in the genuine products and image quality is unstable.

### BRIEF DESCRIPTION OF THE DRAWINGS

FIG. 1 is an exemplary perspective view of a schematic shape of an image forming apparatus according to a first embodiment;

FIG. 2 is an exemplary schematic diagram of the image forming apparatus according to the first embodiment;

FIG. 3 is an exemplary diagram of the arrangement of a density sensor of the image forming apparatus according to the first embodiment;

FIG. 4 is an exemplary external view of an operation panel provided in an MFP according to the first embodiment;

FIG. 5 is an exemplary diagram of the configuration of a control system for the MFP according to the first embodiment and a connection state of the MFP to an external apparatus;

FIG. 6 is an exemplary flowchart for explaining operation for checking consumables of the MFP according to the first embodiment;

FIG. 7 is an exemplary screen for urging a user to instruct execution of image quality maintenance control of the MFP according to the first embodiment;

FIG. 8 is an exemplary flowchart for explaining an image quality maintenance control procedure of the MFP according to the first embodiment;

FIG. 9 is a diagram of patch data for the image quality maintenance control of the MFP according to the first embodiment;

FIG. 10 is an exemplary diagram for explaining a relation among a detection value of a density sensor, a toner deposit on a transfer belt, and image density in the first embodiment; and

FIG. 11 is an exemplary screen for displaying a message to the effect that image quality maintenance control of a MFP according to a second embodiment is executed.

### DETAILED DESCRIPTION

In general, according to one embodiment, an image forming apparatus includes: an image forming section configured to form an image and output the image to a medium; at least one or more detachable consumables including storage media having predetermined information stored therein; a reading module configured to read the predetermined information from the storage media; and a controller configured to output, if the image forming apparatus is instructed to start a predetermined operation and the controller determines that the predetermined information is not present in a storage medium of a consumable related to the operation, a message for urging a user to input an instruction for executing a process for extracting an image forming condition corresponding to the consumable and, if an instruction for executing the process is input, start the predetermined operation after executing operation for extracting a condition for forming an image.

### First Embodiment

A MFP (Multi Function Peripheral), which is an image forming apparatus of an electrophotographic system, is explained as an example of an image forming apparatus according to a first embodiment. The MFP means a digital complex machine for not only scanning, reading, and copying an image at designated resolution and a designated sheet size but also comprehensively utilizing functions of various office apparatuses such as an image receiving function by a facsimile, an image receiving function by e-mail, and a printed image receiving function by a network.

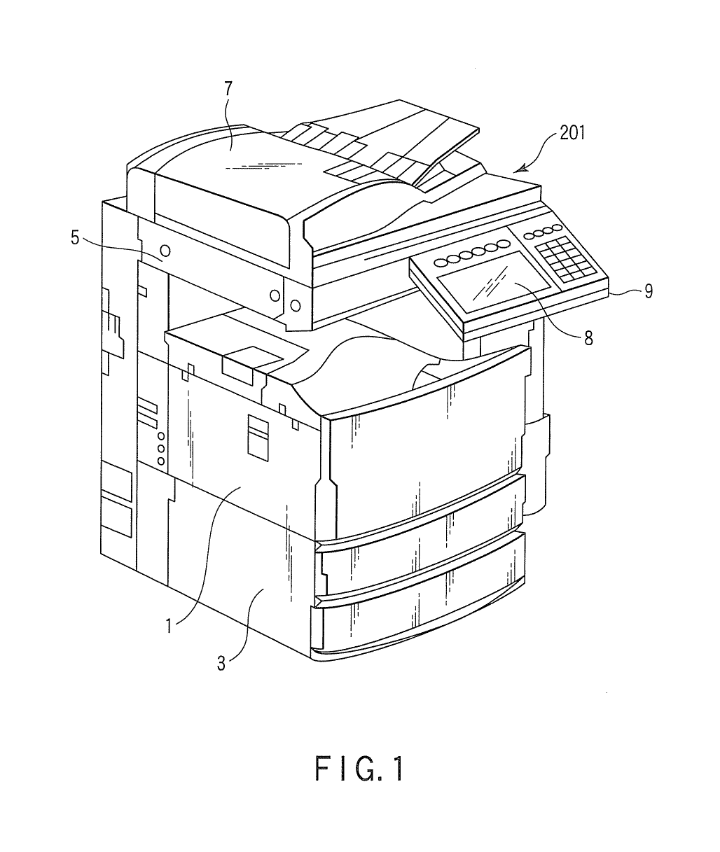

FIG. 1 is an exemplary perspective view of a schematic shape of the image forming apparatus according to the first embodiment.

A MFP 201 includes a print section 1, a sheet tray 3, a scan section 5, an auto feed section 7, and an operation panel 9.

The print section 1 outputs image information as an output image called, for example, a hard copy or a printout. The sheet tray 3 feeds a medium, which is a sheet of an arbitrary size, used for the image output to the print section 1. The scan section 5 captures image information from an original document as image data. The auto feed section 7 feeds the original document, for which reading ends, from a reading position to a discharge position and leads the next original document to the reading position. The operation panel 9 is an instruction input section for instructing the operations of the MFP 201 such as the start of image formation in the print section 1 and the start of reading of image information of an original document by the scan section 5. The operation panel 9 includes a display section 8 including an LCD (Liquid Crystal Device) for receiving input of an instruction and displaying information to an operator.

The MFP 201 can be connected to a not-shown network or communication line and receive image data by facsimile, e-mail, or the like.

An image forming operation in the image forming apparatus is explained.

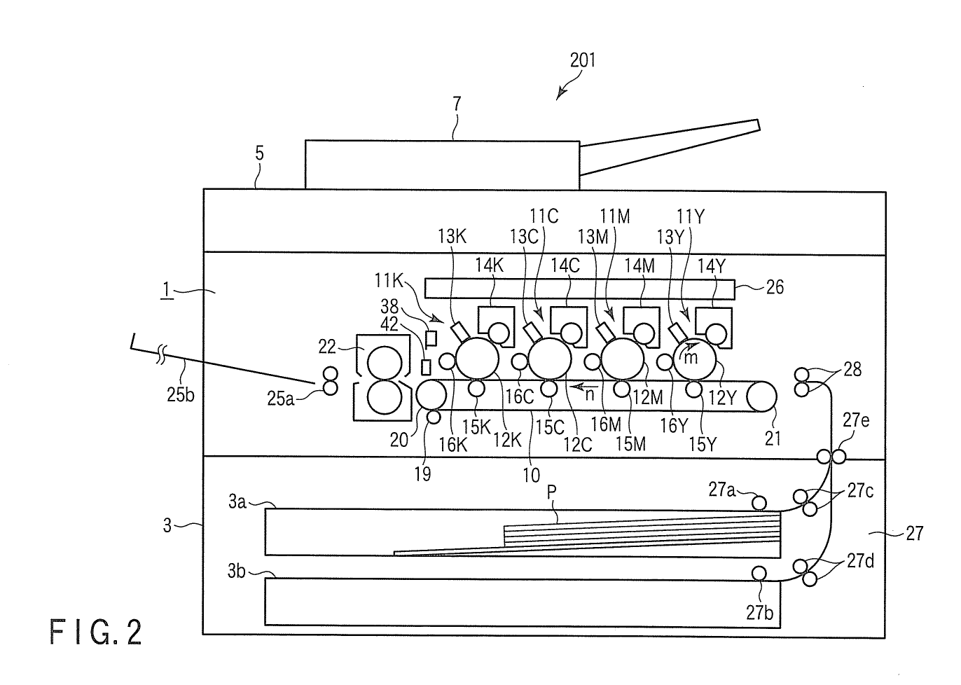

FIG. 2 is an exemplary schematic diagram of an image forming apparatus according to the first embodiment. The MFP 201 is a color copying machine of a quadruple tandem system. The MFP 201 includes four sets of image forming stations 11Y, 11M, 11C, and 11K for yellow (Y), magenta (M), cyan (C), and black (K) arranged in parallel along a transfer belt 10.

The image forming stations 11Y, 11M, 11C, and 11K respectively include photoconductive drums 12Y, 12M, 12C, and 12K, which are image bearing members. Rotation axes of the photoconductive drums 12Y, 12M, 12C, and 12K are set parallel to a direction (a main scanning direction) orthogonal to a traveling direction (a sub-scanning direction) in an arrow n direction of the transfer belt 10. The rotation axes of the photoconductive drums 12Y, 12M, 12C, and 12K are arranged at equal intervals from one another along the sub-scanning direction.

Around the photoconductive drums 12Y, 12M, 12C, and 12K, electrifying chargers 13Y, 13M, 13C, and 13K, developing devices 14Y, 14M, 14C, and 14K, which are developing sections, and photoconductive member cleaners 16Y, 16M, 16C, and 16K are arranged along a rotating direction in an arrow m direction. The developing devices 14Y, 14M, 14C, and 14K respectively include developers of different colors of yellow (Y), magenta (M), cyan (C), and black (K). The developing devices 14Y, 14M, 14C, and 14K respectively develop electrostatic latent images on the photoconductive drums 12Y, 12M, 12C, and 12K and form toner images of the respective colors on the photoconductive drums 12Y, 12M, 12C, and 12K.

A laser exposure device 26, which is a latent-image writing section, irradiates laser exposure beams respectively on the photoconductive drums 12Y, 12M, 12C, and 12K. The laser exposure beams are respectively based on data of color components of image data. The laser exposure device 26 forms electrostatic latent images respectively on the photoconductive drums 12Y, 12M, 12C, and 12K.

The transfer belt 10 is supported by a driving roller 20 and a driven roller 21 and rotated in the arrow n direction. The toner images formed on the photoconductive drums 12Y, 12M, 12C, and 12K are transferred onto a medium P, which is a recording medium, conveyed in the arrow n direction by the transfer belt 10 in the positions of transfer rollers 15Y, 15M, 15C, and 15K. A color toner image is formed on the medium P conveyed by the transfer belt 10. The transfer belt 10 and the transfer rollers 15Y, 15M, 15C, and 15K configure a transfer section.

The medium P is fed from the sheet tray 3 including first and second paper feeding cassettes 3a and 3b to the transfer belt 10 through a conveying section 27. The conveying section 27 includes pickup rollers 27a and 27b configured to pick up the medium P from the paper feeding cassettes 3a and 3b, separating and conveying rollers 27c and 27d, a conveying roller 27e, and a registration roller 28.

The color toner image formed on the medium P is fixed by the fixing device 22 and a color image is completed. Thereafter, the medium P is discharged to a paper discharge tray 25b through a paper discharge roller 25a. After the transfer ends, the photoconductive drums 12Y, 12M, 12C, and 12K are cleaned by the photoconductive member cleaners 16Y, 16M, 16C, and 16K and residual toners are removed from the photoconductive drums 12Y, 12M, 12C, and 12K to enable the next printing.

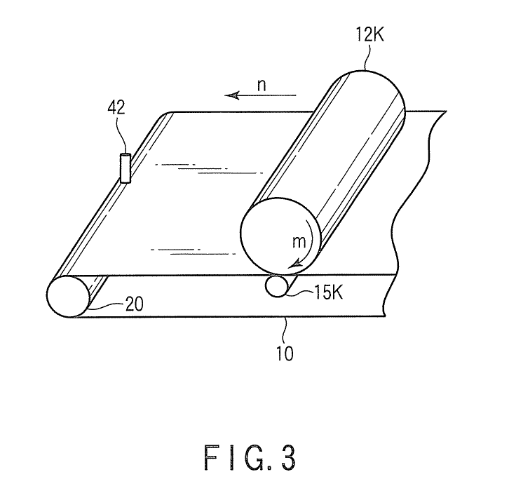

FIG. 3 is an exemplary diagram of the arrangement of a density sensor of the image forming apparatus according to the first embodiment.

As shown in FIG. 3, a density sensor 42 is provided downstream of an image forming station 11K for black (K) of the transfer belt 10. The density sensor 42 is used for image quality maintenance control. A temperature and humidity sensor 38 configured to detect the environment in a main body of the MFP 201 is provided in an upstream direction of the density sensor 42.

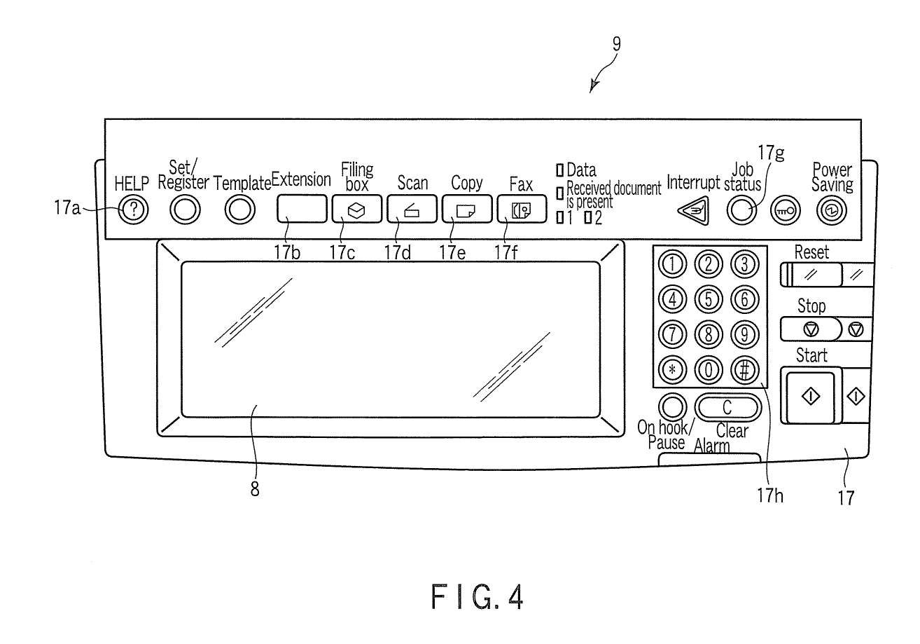

FIG. 4 is an exemplary external view of the operation panel 9 provided in the MFP 201 according to the first embodiment. A user performs setting and check of the MFP 201 via the operation penal 9. The operation panel 9 includes the display section 8 and an operation section 17. The display section 8 includes a touch panel. A state and an operation procedure of the MFP 201, various instructions to the user, and the like are displayed on the display section 8. The operation section 17 includes various operation buttons for operating the MFP 201.

As keys for invoking screens for selecting and setting functions, a help button 17a, a function extension button 17b, a filing box button 17c, a scan button 17d, a copy button 17e, a facsimile button 17f, a state check button 17g, and the like are arranged on the operation panel 9. Other number keys 17h and the like for setting value input and information check are also arranged on the operation panel 9.

Functions of main buttons among these operation buttons are explained below. The user uses the help button 17a when the user inquires what kind of operation should be performed next. The user uses the extension button 17b when the user uses an extended function. The user uses the filing box button 17c when the user extracts stored image data. The user uses the scan button 17d when the user uses a scan function. The user uses the copy button 17e when the user uses a copy function. The user uses the facsimile button 17f when the user uses a facsimile function. The user uses the state check button 17g when the user executes private printing. The user uses the ten key 17h when the user inputs a number.

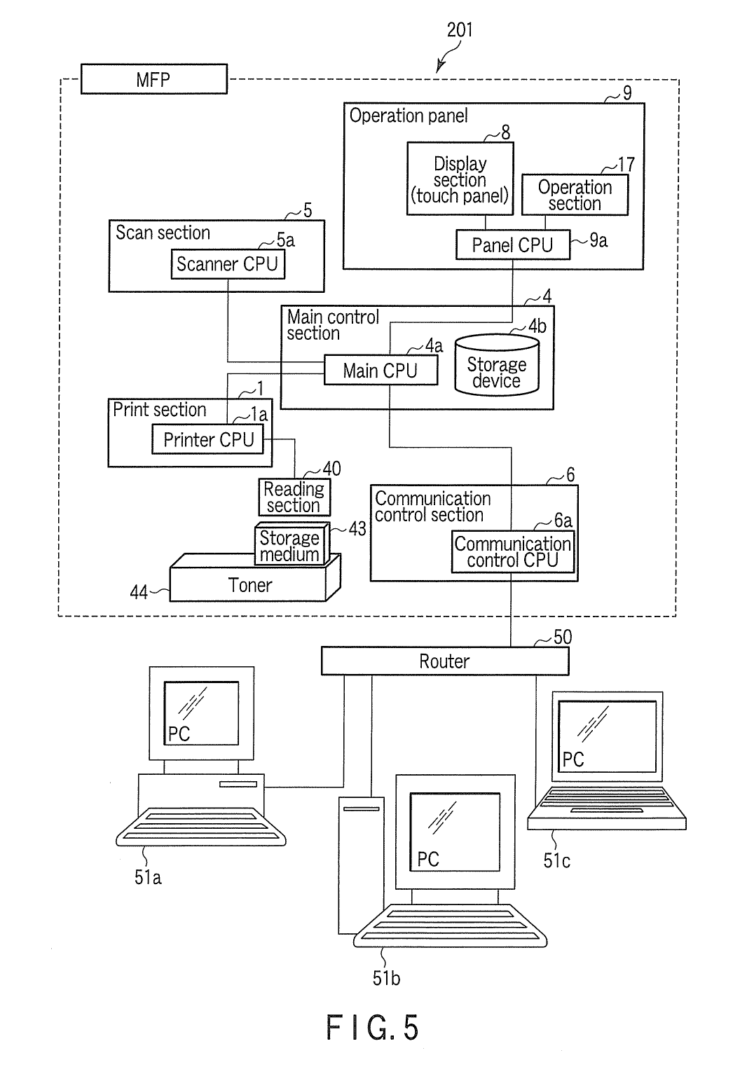

FIG. 5 is an exemplary diagram of the configuration of a control system for the MFP 201 according to the first embodiment and a connection state of the MFP 201 to an external apparatus.

The MFP 201 includes five CPUs, i.e., a main CPU (Central Processing Unit) 4a in the main control section 4, a scanner CPU 5a of the scan section 5, a printer CPU 1a of the print section 1, a panel CPU 9a of the operation panel 9, and a communication control CPU 6a of a communication control section 6.

The main CPU 4a performs bidirectional communication with the printer CPU 1a via a shared RAM (Random Access Memory). The main CPU 4a outputs an operation instruction and the printer CPU 1a returns a status. The printer CPU 1a and the scanner CPU 5a exchange information through serial communication. The printer CPU 1a outputs an operation instruction and the scanner CPU 5a returns a status.

The operation panel 9 includes, as explained above, the display section 8 including the touch panel, the operation section 17 including the various operation keys, and the panel CPU 9a connected to the display section 8 and the operation section 17. The panel CPU 9a is connected to the main CPU 4a and exchanges information.

The communication control CPU 6a is an interface configured to perform information exchange with plural PCs (Personal Computers) 51a to 51c, which are external apparatuses, via a router 50. The main CPU 4a is connected to the communication control CPU 6a and exchanges information with the external apparatuses.

The main CPU 4a collectively controls the MFP 201. The main control section 4 includes a storage device 4b. Computer programs for controlling the operation of the MFP 201, image information, and the like are stored in the storage device 4b.

The MFP 201 includes a consumable including a storage medium and includes a reading section 40 configured to read out information from the storage medium. In FIG. 5, a toner cartridge 44 including a storage medium 43 is disclosed as an example.

The consumable is not limited to the toner cartridge 44 and may be the photoconductive drums 12Y, 12M, 12C, and 12K or may be the transfer rollers 15Y, 15M, 15C, and 15K. The consumable may be a toner supplied to the toner cartridge 44. The storage medium may include an IC chip or an RFID (Radio Frequency Identification).

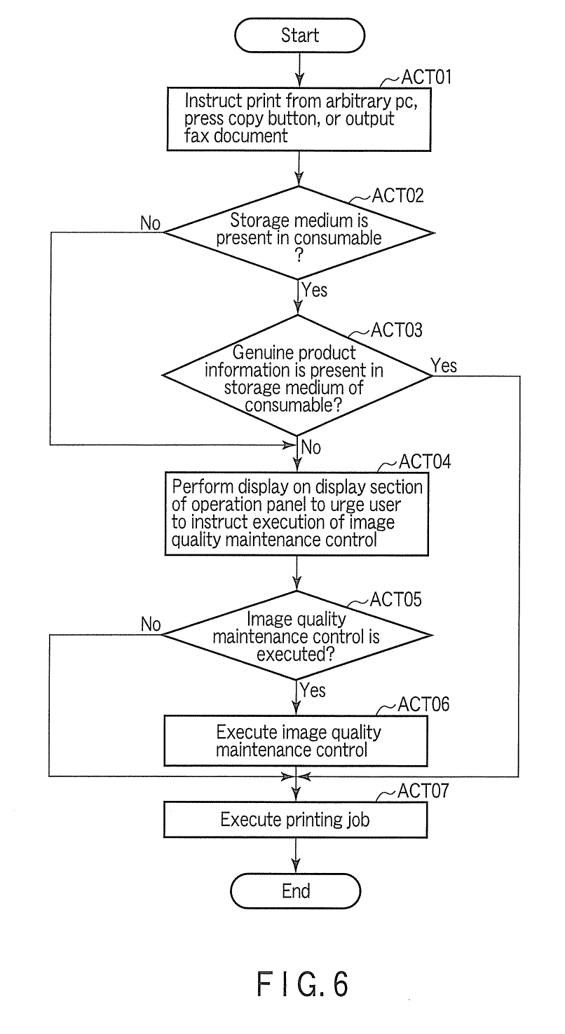

FIG. 6 is an exemplary flowchart for explaining a consumable check operation of the MFP 201 according to the first embodiment.

In ACT 01, the user inputs an instruction for executing a printing job to the MFP 201. This instruction input is generated by input of a print instruction from an arbitrary one of the PCs 51a to 51c, pressing of the copy button 17e on the operation panel 9, pressing of the facsimile button 17f on the operation panel 9, or the like.

In ACT 02, the printer CPU 1a checks whether the storage medium 43 is provided in the toner cartridge 44. As the toner cartridge 44 to be checked, four kinds of toner cartridges 44Y, 44M, 44C, and 44K for Y, M, C, and K are provided. The printer CPU 1a checks whether storage media 43Y to 43K are provided in all the four kinds of toner cartridges 44Y to 44K.

If the storage media 43Y to 43K are provided in all the toner cartridges 44Y to 44K (Yes in ACT 02), in ACT 03, the printer CPU 1a checks whether information concerning genuine products is present in the storage media 43Y to 43K. Information indicating that toners are genuine products, toner manufacture information (e.g., a manufacturing place and lot numbers), information concerning colors, information concerning the number of prints used, and other information are stored in the storage media 43Y to 43K. The information concerning genuine products includes a manufacturer name and model numbers representing the toners. The printer CPU 1a determines whether the toners are genuine products according to whether at least one or plural kinds of information among these kinds of information are present.

If the information concerning genuine products is present in all the storage media 43Y to 43K (Yes in ACT 03), in ACT 07, the printer CPU 1a executes a printing job.

If the storage media 43Y to 43K are not provided in at least one of the toner cartridges 44Y to 44K (No in ACT 02) or if the information concerning genuine products is not present in at least one of the storage media 43Y to 43K (No in ACT 03), in ACT 04, the panel CPU 9a performs display on the display section 8 of the operation panel 9 to urge the user to instruct execution of image quality maintenance control.

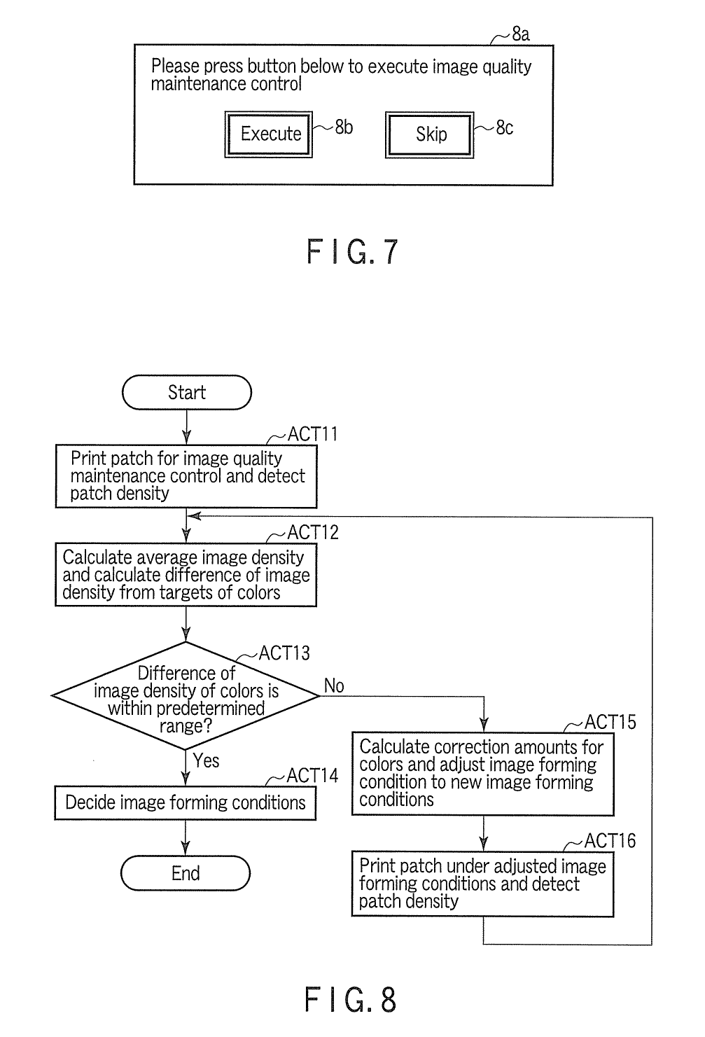

FIG. 7 is an exemplary screen for urging the user to instruct execution of image quality maintenance control of the MFP 201 according to the first embodiment. A screen 8a includes an execution button 8b and a skip button 8c together with a message for urging the image quality maintenance control. The panel CPU 9a acquires input of a button operated by the user on the screen 8a.

If the user presses the execution button 8b (Yes in ACT 05), in ACT 06, the printer CPU 1a executes the image quality maintenance control. A detailed procedure of the image quality maintenance control is explained later. In ACT 07, the printer CPU 1a executes a printing job after executing the image quality maintenance control.

If the user presses the skip button 8c (No in ACT 05), the printer CPU 1a executes the printing job in Act 07 without executing the image quality maintenance control.

FIG. 8 is an exemplary flowchart for explaining an image quality maintenance control procedure of the MFP 201 according to the first embodiment.

In ACT 11, the printer CPU 1a prints a patch, which is a toner image for image quality maintenance control, on the transfer belt 10 using patch data for the image quality maintenance control. The density sensor 42 detects the density of the printed patch.

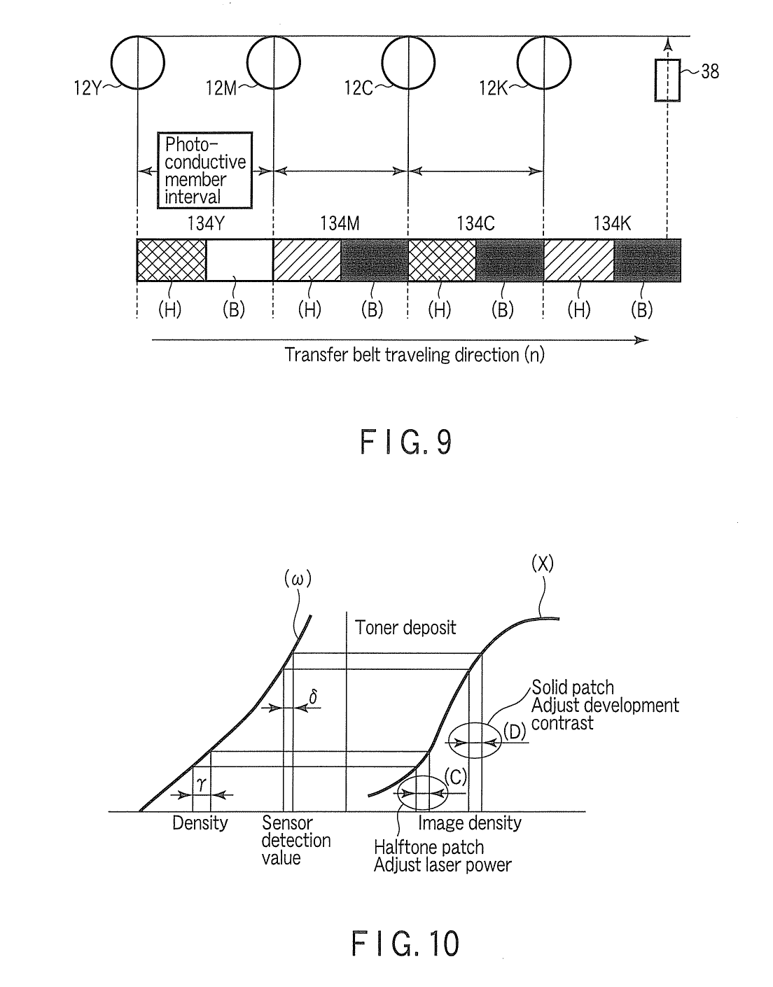

FIG. 9 is a diagram of the patch data for the image quality maintenance control of the MFP 201 according to the first embodiment. As shown in FIG. 9, the printer CPU 1a prints patches 134Y, 134M, 134C, and 134K of the respective color components on the transfer belt 10. The print of the patches 134Y, 134M, 134C, and 134K is simultaneously started for all the colors. When the patches 134Y, 134M, 134C, and 134K are printed by the length of an interval among the photoconductive drums 12Y, 12M, 12C, and 12K, the print is simultaneously stopped for all the colors. The patches 134Y, 134M, 134C, and 134K of the four colors are arranged on the transfer belt 10 without gaps. The patches 134Y, 134M, 134C, and 134K of the four colors is one set of patches.

The patches 134Y, 134M, 134C, and 134K of the four colors include, for each of the color components, a solid patch (B) and a halftone patch (H) formed by halftone dots of a specified pattern. The density sensor 42 detects toner deposits at twelve points in each of the solid patch (B) and the halftone patch (H).

In ACT 12, the printer CPU 1a calculates an average of detection values of the density sensor 42 and decides a detection value of the density sensor 42. The printer CPU 1a calculates a difference between a target value of image density of each of the color components and the decided detection value of the density sensor 42.

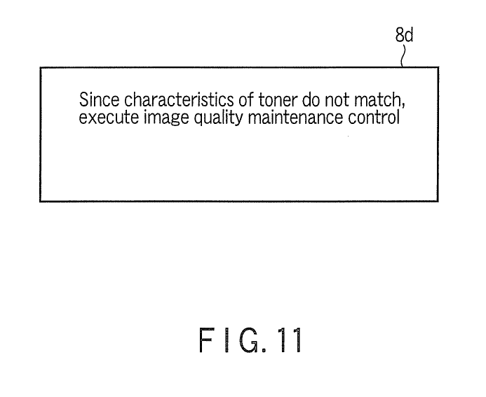

FIG. 10 is an exemplary diagram for explaining a relation among the detection value of the density sensor 42, a toner deposit on the transfer belt 10, and image density in the first embodiment. In FIG. 10, a solid line (w) indicates the detection value of the density sensor 42 and a solid line (x) indicates the toner deposit on the transfer belt 10.

A range of the detection value of the density sensor 42 is determined according to a target range of the image density with reference to FIG. 10. For example, if a target range of image density of the halftone patch (H) is (C), the range of the detection value of the density sensor 42 is determined as (γ). If a target range of image density of the solid patch (B) is (D), the range of the detection value of the density sensor 42 is determined as (δ).

In ACT 13, the printer CPU 1a discriminates whether the difference between the target value of the image density of each of the color components and the detection value is within a predetermined range. If the difference between the target value of the image density of each of the color components and the detection value is within the predetermined range (Yes in ACT 13), in ACT 14, the printer CPU 1a decides image forming conditions and ends the image quality maintenance control.

If the difference between the target value of the image density of each of the color components and the detection value exceeds the predetermined range (No in ACT 13), in ACT 15, the printer CPU 1a adjusts the image forming conditions for each of the color components. The printer CPU 1a adjusts a development contrast Vc such that the image density of the solid patch (B) reaches the target value. The printer CPU 1a adjusts a laser beam amount Lp such that the image density of the halftone patch (H) reaches the target value. The printer CPU 1a adjusts the image density at the two points of the solid patch (B) and the halftone patch (H) and more precisely adjusts the image density.

In ACT 16, the printer CPU 1a prints the solid patch (B) and the halftone patch (H) on the transfer belt 10 using patch data for density detection under the adjusted image forming conditions. The printer CPU 1a detects the density of a printed pattern. The printer CPU 1a proceeds to ACT 12 and repeatedly executes the processing explained above.

When the printer CPU 1a completes the image quality maintenance control according to the flowchart of FIG. 8, the belt cleaner 19 removes the pattern and the patches on the transfer belt 10. As explained above, after the completion of the image quality maintenance control, the MFP 201 performs desired print on the medium P according to image data under the adjusted image forming conditions.

The image quality maintenance control explained with reference to the flowchart of FIG. 8 can be grasped as control for changing conditions for forming an image.

In the embodiment explained above, when an instruction for staring a desired operation of the MFP 201 is input, the MFP 201 checks whether a consumable related to the operation is a genuine product. If the consumable is not the genuine product, the MFP 201 performs display for urging the user to instruct execution of the image quality maintenance control. When the user instructs execution of the image quality maintenance control, the MFP 201 starts the desired operation after executing the image quality maintenance control.

Therefore, even if a non-genuine consumable, which is often not confirmed to have sufficient performance, is used, it is possible to obtain a stable image.

Since the user is requested to instruct execution of the image quality maintenance control, it is possible to cause the user to recognize that a genuine product is effective for image quality maintenance.

### Second Embodiment

The second embodiment is different from the first embodiment in contents displayed on the display section 8 of the operation panel 9 when a non-genuine consumable is used. Therefore, components same as those in the first embodiment are denoted by the same reference numerals and signs and explanation of the components is omitted.

FIG. 11 is an exemplary screen for displaying a message to the effect that image quality control of the MFP 201 according to a second embodiment is executed.

In the second embodiment, if a non-genuine consumable is used, a message to the effect that the image quality maintenance control is executed and a reason for the execution of the image quality maintenance are displayed on the screen 8d. The image quality maintenance control is forcibly executed.

According to the second embodiment, even if a non-genuine consumable, which is often not confirmed to have sufficient performance, is used, it is possible to obtain a stable image.

Since a reason for forcibly executing the image quality maintenance control is indicated to a user, it is possible to cause the user to recognize that a genuine product is effective for image quality maintenance.

This application is not limited to the embodiments and can be variously changed. For example, the structure of the image forming apparatus is not limited. In the case of an image forming apparatus of a quadruple tandem system, the image forming apparatus may be an apparatus that performs color print using an intermediate transfer belt. The structure of the image forming apparatus may be an image forming apparatus of a four-rotation intermediate transfer system. The structure of the image forming apparatus may be an image forming apparatus of a multiple transfer (transfer drum) system. Further, the structure of the image forming apparatus may be an image forming apparatus of a collective transfer (multiple development) system.

The structure of the image forming apparatus may be an image forming apparatus of an ink jet system. In the case of the ink jet system, consumables can be liquid or gel ink or an ink cartridge.

A barcode can be used instead of the storage medium 43 used in the embodiments.

The functions explained in the embodiments may be configured using hardware or may be realized by causing a computer to read a computer program that describes the functions using software. The functions may be configured by selecting the software or the hardware as appropriate.

Further, the functions can also be realized by causing the computer to read a computer program stored in a not-shown recording medium. A recording format of the recording medium in the embodiments may be any form as long as the recording medium can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section configured to form an image and output the image to a medium;
at least one or more detachable consumables including storage media having predetermined information stored therein;
a reading module configured to read the predetermined information from the storage media; and
a controller configured to output, if the image forming apparatus is instructed to start a predetermined operation and the controller determines that the predetermined information is not present in a storage medium of a consumable related to the operation, a message for urging a user to input an instruction for executing a process for extracting an image forming condition corresponding to the consumable and, if an instruction for executing the process is input, start the predetermined operation after executing operation for extracting a condition for forming an image.

2. The apparatus according to claim 1, wherein the predetermined information is information representing that the consumable is a genuine product.

3. The apparatus according to claim 2, wherein
the apparatus is an image forming apparatus of an electrophotographic system,
the consumable is a toner; and
the predetermined operation is print on the medium.

4. The apparatus according to claim 3, wherein the operation for extracting a condition for forming an image is operation for extracting an image forming condition such that density of a pattern image to be formed is within a predetermined range.

5. The apparatus according to claim 4, wherein the storage medium is an IC chip or a barcode.

6. The apparatus according to claim 3, wherein
the apparatus has a color image forming function, and
the controller outputs, if the image forming apparatus is instructed to start print and the controller determines that the predetermined information is not present in a storage medium of at least one of plural toner cartridges for different colors, a message for urging the user to input an instruction for executing a process for extracting an image forming condition corresponding to the toner cartridge and, if an instruction for executing the process is input, start the print after executing operation for extracting a condition for forming an image.

7. The apparatus according to claim 6, wherein the operation for extracting a condition for forming an image is operation for extracting an image forming condition such that density of pattern images of respective colors to be formed is within a predetermined range.

8. The apparatus according to claim 7, wherein the storage medium is an IC chip or a barcode.

9. The apparatus according to claim 2, wherein
the apparatus is an image forming apparatus of an ink jet system,
the consumable is a cartridge of liquid ink or gel ink, and
the predetermined operation is print on the medium.

10. The apparatus according to claim 9, wherein the storage medium is an IC chip or a barcode.

11. An image forming method for an image forming apparatus including: an image forming section configured to form an image and output the image to a medium; at least one or more detachable consumables including storage media having predetermined information stored therein; and a reading module configured to read the predetermined information from the storage media,
the method comprising:
determining, if the image forming apparatus is instructed to start a predetermined operation, whether the predetermined information is present in a storage medium of a consumable related to the operation;
outputting, if it is determined that the predetermined information is not present, a message for urging a user to input an instruction for executing a process for extracting an image forming condition corresponding to the consumable; and
starting, if an instruction for executing the process is input, the predetermined operation after executing operation for extracting a condition for forming an image.

12. The method according to claim 11, wherein the predetermined information is information representing that the consumable is a genuine product.

13. The method according to claim 12, wherein
the image forming apparatus is an image forming apparatus of an electrophotographic system,
the consumable is a toner; and
the predetermined operation is print on the medium.

14. The method according to claim 13, wherein the operation for extracting a condition for forming an image is operation for extracting an image forming condition such that density of a pattern image to be formed is within a predetermined range.

15. The method according to claim 14, wherein the storage medium is an IC chip or a barcode.

16. The method according to claim 13, wherein
the image forming apparatus has a color image forming function, and
the determining includes determining whether the predetermined information is present in storage media of all of plural toner cartridges for different colors.

17. The method according to claim 16, wherein the operation for extracting a condition for forming an image is operation for extracting an image forming condition such that density of pattern images of respective colors to be formed is within a predetermined range.

18. The method according to claim 17, wherein the storage medium is an IC chip or a barcode.

19. The method according to claim 12, wherein
the image forming apparatus is an image forming apparatus of an ink jet system,
the consumable is a cartridge of liquid ink or gel ink, and
the predetermined operation is print on the medium.

20. The method according to claim 19, wherein the storage medium is an IC chip or a barcode.
